(19) United States
(12) Patent Application Publication
(10) Pub. No.: US 2015/0293669 A1
(43) Pub. Date: Oct. 15, 2015

(54) APPARATUS, METHOD, AND COMPUTER SYSTEM FOR GENERATING CONTAINED, USABLE OBJECTS THAT ARE DYNAMICALLY CONFIGURABLE

(71) Applicant: ZULAHOO, INC., Irving, TX (US)

(72) Inventor: Jon Prichard, Grand Prairie, TX (US)

(73) Assignee: ZULAHOO, INC., Irving, TX (US)

(21) Appl. No.: 14/530,069

(22) Filed: Oct. 31, 2014

Related U.S. Application Data
(60) Provisional application No. 61/977,381, filed on Apr. 9, 2014.

(51) Int. Cl. G06F 3/0484; H04L 29/08

(52) U.S. Cl. CPC G06F 3/04842; H04L 67/10; H04L 67/02

(57) ABSTRACT

The present disclosure provides a system and a method for enabling interoperability between digital systems. In one aspect, the method comprises generating a process appliance container by concatenating two or more process appliances, the process appliance container comprising core logic and functional elements associated with the core logic; transmitting the process appliance container to a process interpolation terminal; and rendering an output on the process interpolation terminal in accordance with the core logic and the functional elements of the process appliance container.

### RELATED APPLICATION

This application claims the benefit of priority to U.S. Provisional Patent Application Ser. No. 61/977,381, filed on Apr. 9, 2014, the entire contents of which are incorporated herein by reference for all purposes.

### BACKGROUND

The present disclosure relates to a digitally-based computer system providing organic-like function, as the practical application of a programming structure for generating contained, usable objects that dynamically configure themselves, correct error, create security, learn, adapt, are context aware and are accessed and used through self-explained application driven appliances.

Due to the ubiquity of web browsers and the convenience of using web browsers as a client terminal, information technology has been advanced to a unprecedented level to allow users to perform almost all kinds of functionalities through web browsers (e.g., web-based office automation, web-based gaming, web-based electronic commerce, etc.). Current web-based functionalities, however, are limited to the particular design of the visited websites, and are not interoperable among websites designed and operated by different parties. Moreover, current web-based functionalities are not easily configurable by the users.

Accordingly, there is a need to develop a new system and a new method that enable interoperability between different web-based systems and that are dynamically configurable by the users.

### SUMMARY

Certain embodiments of the present disclosure provide a system that can be used to create a “private” social media in an intranet, in which members/administrators/account holders may invite others to register as members of the “operating system” and become members of the inviter's intranet (community). The administrator of the intranet may appoint other administrators. In some implementations, there may be “attached accounts” with limited or supervised community privileges for minors attached to the accounts of guardians (parents) who have greater community and operating system privileges. Moreover, the system of the present disclosure can place or connect the communities to an environment (such as, MixMoo™).

Certain embodiments of the present disclosure provide a system that can create and manage standard/customized process appliance containers for delivery of processes or process appliances to be consumed by a user's process interpolation terminal. A service provider may charge a fee for the provision of standard/customized process appliance containers, the usage of which may be recorded within the process appliance containers.

Certain embodiments of the present disclosure provide a system that includes security/privacy buffers between commercial interests and private community interests. The disclosed system employs technologies, algorithms, and protocols that enable the sale and promotion of goods, services into specifically purposed private spheres.

Certain embodiments of the present disclosure provide a system that enables the interoperability between the community environment and disparate software/hardware platforms. Data may be taken from the machine abstraction layer, and then compiled and ported through a web browser's rendering engine.

Certain embodiments of the present disclosure provide a system that enables behavioral, contextual, mechanical, relevance, action and conditional pattern matching between application and operation elements.

Certain embodiments of the present disclosure provide a system that utilizes the Media Intergraph Model (MIM) or a Process Interpolation/Interchange Platform (PIP) to create immersive online environments that replaces the current Internet standard known as the Document Object Model (DOM).

In one aspect, the present disclosure provides a method for enabling interoperability between digital systems, comprising generating a process appliance container by concatenating two or more process appliances, the process appliance container comprising core logic and functional elements associated with the core logic; transmitting the process appliance container to a process interpolation terminal; and rendering an output on the process interpolation terminal in accordance with the core logic and the functional elements of the process appliance container.

In one embodiment, each of the process appliances comprises a modeling expression associated therewith.

In one embodiment, the modeling expression comprises behavior expression, context expression, mechanics expression, and relevance expression.

In one embodiment, generating the process appliance container comprises reading a persistent expression from a data store, the persistent expression being associated with a standard process appliance; receiving a convection expression from an operator through the process interpolation terminal; receiving a boost expression from a creator through the data store; comparing the convection expression and the boost expression; concatenating the convection expression and the boost expression to obtain a matching expressing; and generating the process appliance container in accordance with the matching expressing.

In another aspect, the present disclosure provides a system for enabling interoperability between digital systems, comprising a process appliance concatenation apparatus (PACA) configured to generate a process appliance container including one or more process appliances; an interoperable managed process appliance concatenation terminal (IMPACT) configured to distribute the process appliances; and a processes interpolation/interchange platform (PIP) configured to consume the process appliances through a user interface and user experience platform of the PIP.

In one embodiment, the user interface and user experience platform comprises a web browser.

In one embodiment, the system further comprises a data store configured to store the process appliance container.

In yet another aspect, the present disclosure provides a computer system comprising a network-enabled terminal device including at least a processor, a memory, and a display device, a web browser program stored in the memory and executable by the processor to provide visual output to the display device, a process appliance compiler stored in the memory and executable by the processor through the web browser program, and a process appliance container object generated by the process appliance compiler, the process appliance container object being stored in the memory and executable by the processor through the web browser program, the process appliance container object comprising one or more appliance objects and one or more data objects.

In one embodiment, the appliance objects are executable through the web browser program and the data objects are non-executable through the web browser program. The one or more appliance objects comprise codes of a scripting language. The data objects comprise one or more of actions data object, behaviors data object, mechanics data object, relevance data object, context data object, and conditions data object.

In one embodiment, the appliance objects comprise one or more of user interface/user experience (UI/X) appliance object, interoperability engine object, purpose engine object, and security appliance object. The UI/X appliance object comprises one or more of an interface appliance object, a rendering appliance object, and a media intergraph model object. The interoperability engine object comprises one or more of an appliance synchronization object and a system mechanics appliance object. The purpose engine object comprises one or more of an operation appliance object, and a context, relevance and conditions object. The security appliance object comprises one or more of a device object, a session object, a user object, and a network object.

In one embodiment, the network-enabled terminal device further includes a persistent local data storage device configured to store local process appliance container objects. The persistent local data storage device comprises a local asset processor configured to retrieve and compile digital assets into one or more of the local process appliance container objects in accordance with a request received through interaction with the visual output.

In one embodiment, the computer system further comprises a persistent remote data storage device accessible by the network-enabled terminal device through a computer network, the persistent remote data storage device being configured to store remote process appliance container objects and a core logic library. The persistent remote data storage device comprises a remote asset processor configured to retrieve and compile digital assets from the core logic library into one or more of the remote process appliance container objects in accordance with a request received through interaction with the visual output. The remote process appliance container objects can be hosted by a database server.

In still another aspect, the present disclosure provides a network-enabled computer apparatus, comprising: computer hardware including a processor, an input device, and an output device; a web browser program executed by the processor to receive user input from the input device and provide visual output to the output device; a plurality of process appliances executed by the processor through the web browser program.

In one embodiment, the plurality of process appliances comprises: an abstraction layer configured to provide an interface between the computer hardware and one or more of the executed process appliances; an appliance object compiler configured to generate a process appliance container object based on digital assets retrieved from one or more sources; an application layer configured to execute the process appliance container object through the web browser program; a rendering mechanism configured to render content of the visual output in accordance with the executed process appliance container object; a consumption interface configured to output the rendered content to the output device; and a digitizing layer configured to process user interaction from the input device.

In one embodiment, the application layer comprises application software drivers and objects.

In one embodiment, the abstraction layer comprises one or more of display abstractions, print/save abstractions, load/boot abstractions, data extraction abstractions, and terminal access abstractions.

In one embodiment, the abstraction layer comprises a first process appliance container object generated by the appliance object compiler.

In one embodiment, the plurality of process appliances further comprises a device net. The first process appliance container object comprises local abstraction objects retrieved from a local data storage device through the device net.

In one embodiment, the plurality of process appliances further comprises a network mechanism. The first process appliance container object comprises remote abstraction objects retrieved from a remote data storage device through the network mechanism.

In one embodiment, the first process appliance container object comprises local abstraction objects retrieved from a local data storage device and remote abstraction objects retrieved from a remote data storage device.

### BRIEF DESCRIPTION OF THE DRAWINGS

For a better understanding of the present disclosure, together with other and further needs thereof, reference is made to the accompanying drawings and detailed description.

FIG. 1 illustrates a computer system for creation, deployment, consumption and management of a process appliance container (PAQ), in accordance with an embodiment of the present disclosure.

FIG. 2 illustrates a process appliance container (PAQ) or a PAQ object, in accordance with an embodiment of the present disclosure.

FIG. 3 illustrates a computer architecture for creation, deployment and consumption of commerce process appliances, in accordance with an embodiment of the present disclosure.

FIG. 4 illustrates a flowchart for PAQ and PAQ code compiler operation, in accordance with an embodiment of the present disclosure.

FIG. 5A illustrates a computer system for creation, deployment, consumption and management of a process appliance container (PAQ), in accordance with another embodiment of the present disclosure.

FIG. 5B illustrates details of the abstraction layer shown in FIG. 5A.

FIG. 5C illustrates details of the network mechanism shown in FIG. 5A.

FIGS. 6A-6C schematically illustrate the basic operation, provider function, and provider/user flow of a commerce network system, in accordance with an embodiment of the present disclosure.

FIGS. 7A and 7B schematically illustrate the access, interoperability, and program properties of a process appliance container (PAQ), in accordance with an embodiment of the present disclosure.

### DETAILED DESCRIPTION

### Overview

The present disclosure provides a network operating system (a.k.a., ZuOS) designed to enable the operations of specifically purposed communities. ZuOS incorporates three operational layers, the Intranet Layer, the Extranet Layer and the Exonet Layer. The three operational layers are interoperable with each other and governed by the owners and/or administrators of participating specifically purposed communities. Under ZuOS operations, such communities operate as self-contained and governed properties, with community standards, style and branding considerations, and the responsibility of the community itself.

The Intranet Layer is the “container” where the community's internal data and operations are accessed and consumed.

The Extranet Layer is a container layer “surrounding” the Intranet where extended community data and operations are accessed and consumed. Extranet data and operations are accessed and consumed by “extra-community” stakeholders such as contractors, partners, vendors and customers as a private function between the Intranet and Extranet layers.

The Exonet Layer is a “bridge layer” between the internal layers (Intranet and Extranet) and the world wide web or the Internet. The Exonet Layer provides a protective layer surrounding the internal layers as communities distribute public facing content, data and operations, providing a barrier against public intrusion into the internal layers. Persons and groups unaffiliated with communities, individuals or applications in the disclosed Eco-system are non-authenticated users and as such, access of public facing content is understood as “public participation” in the Exonet Layer.

The three operational layers incorporate proprietary techniques to generate market and technology differentiation factors in five key areas:
Integrated as an overlay to complement existing technology installations.
Interoperable with existing software and infrastructure technologies.
Security Standards meeting regulation and compliance mandates.
Online and Offline data and operations access and consumption.
Common Data Structure for consistent operation and effective management.

Commerce Model

In accordance with the present disclosure, a “provider” can deliver the three operational layers as holistic, service-oriented, architected environments, tailored to the operations and needs of specifically purposed communities. Such communities generate a Community Value Quotient (CVQ) available for targeting by providers of products (goods and services), processes (applications and operations) and promotion (brand building and promotional deployment), creating a unique revenue model and commerce environment for exploitation by all system stakeholders.

In one embodiment, CVQ is defined by size, type, purpose, demographics and geography in alignment with proprietary algorithmic dynamic multi-factor pattern matching schemas. In another embodiment, CVQ can be expanded and defined by size, type, purpose, demographics and geography in alignment with behaviors, context, mechanics, relevance, actions and conditions.

The disclosed commerce model permits end users and organizations to utilize ZuOS operations and community environments without traditional barriers to entry—such as fee-per-user seat licenses. Very low barriers to entry enables mass adoption for individual users and/or organizations to create and manage high-value environments populated by communities with specific community-centric purposes. Such high-value communities then attract revenue streams generated by the deployment of products, processes and promotion into the specifically purposed community environments.

The disclosed commerce model, called the Impact Commerce Network, operates as a distributed network of deployed products, processes and services. Deployment of such commerce is directed by a “provider” while management of the commerce is governed by the community's owners and/or administrators. Deployment through the network operates as a two-part process with both an application “front door” distributed for display inside community space, and a product, process or promotion function application tile, attached to the front door, known as a “Marquee.” Display space for Marquees is purchased by the provider on a “space rental” basis, while the function application tile is purchased by hosting fees and transaction fees. The Impact system enables the deployment of products, processes and promotion throughout the three operational layers and to the World Wide Web. ZuOS and Impact may be integrated as an overlay to existing technologies that support extant installed technology assets, while sharing revenues derived from the products, processes and promotion consumed throughout the specifically purposed community environment.

The operational and content control of products, processes and promotion deployed into specifically purposed communities is governed by the community environment administrator(s) according to that community's standards, need and preferences. In this way administrators can block inappropriate Marquee or application tile content at one or more of the three operational layers. (e.g., an administrator may disallow a product, process or promotion at the Intranet Layer but permit them at the Extranet and Exonet Layers). All products, processes and promotion applications deployed through the Impact network are designed for minimal environment space disruption and are usable as applications accessed from an individual's application storage bin.

Technology Snapshot

In General: The disclosed data manipulation algorithms are based on a multi-factor pattern matching criteria derived from various multi-factor elemental matching structures. In one embodiment, the multi-factor elemental matching structures include (but not limited to) targeting the alignment of products, processes and promotions with the appropriate specifically purposed community without breaching one's browser or compromising one's personal activities. In one embodiment, the multi-factor elemental matching structures can be Quadrantal element matching structures, which include behaviors, mechanics, relevance, context in alignment with the bi-phase interpolation elements of actions and conditions.

Computing Efficiency: The disclosed techniques enhance data compression at data storage layers by also compressing data throughput at the device level. The disclosed data management and display techniques utilize more of the device's assets than found in standard web-based configurations. By aggressively limiting the number and need for server calls, the disclosed system effectively saves costly “network time.”

Standards: The disclosed techniques utilizes web standards object oriented programming as the basis of its software. This includes, but not limited to, HTML5, Dynamic HTML (PHP), CSS, Java, JavaScript.

Development Framework: The disclosed techniques provide a framework for Application Development enabling one development effort for multiple Operating Systems. This eradicates the need to build an application with backdoor access bypassing the normal method of authentication eliminating a vulnerability point for hackers, computer worms, spammers and agents to leverage and access.

Application Linkage: The disclosed techniques integrate with existing applications by utilizing the universal development framework to create synchronized Application Programmable Interfaces (API's) enveloping applications into the disclosed Interoperability Engine. Developers of software are not required to adopt the provider's framework, rather, the provider can adopt published and partnership required API's into its system.

Regulated Data: The disclosed techniques include a method that assigns a structuring technique for unstructured data, which is referred to as Big Data. The disclosed techniques can manage both structured and unstructured data in transit and at rest. Examples of unstructured data include, emails, PDF's, Word documents, Excel spreadsheets, images, video, etc.

Security Eco-System: The disclosed techniques incorporate a multi-factor Dynamic Credential Matching criteria.

Data Ownership: A user account with the provider is operated and governed by its owner. Content data, such as text and photographic posts, that is transferred through and into the account is owned by the account owner (who retains responsibility for such data). Ownership of user data is not transferred to the provider.

Customization: Administrators govern user profiles including access, ability to disable copying and printing functions, track and log activities in alignment with the multi-factor pattern matching criteria.

User Interface/User Experience (UIX) framework is designed to deliver applications and processes in formats that better mirror real-world activities and tasks performed across a broad industry spectrum, as opposed to current web interfaces that are based on publishing standards and activities.

System Architecture

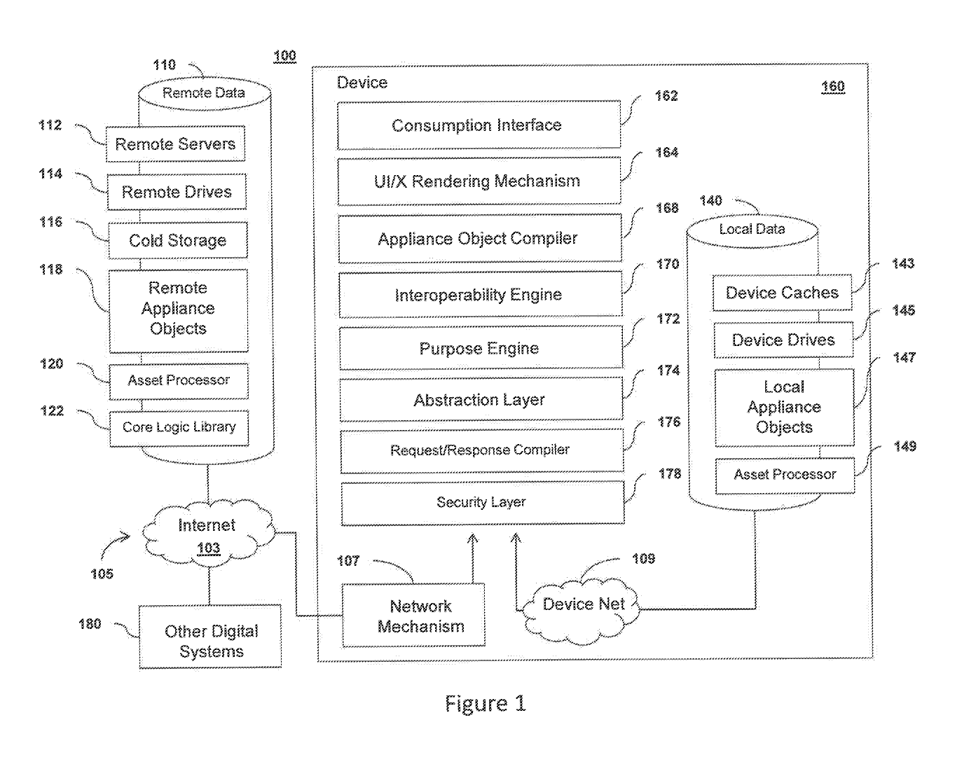

FIG. 1 illustrates a computer system 100 for creation, deployment, consumption and management of a process appliance container (PAQ), in accordance with an embodiment of the present disclosure. In one embodiment, PAQ is a dynamically assembled container including a series of programmed objects (collectively, a PAQ object) capable of delivering a process appliance or appliances to the user interface of a terminal device through the computer system shown in FIG. 1.

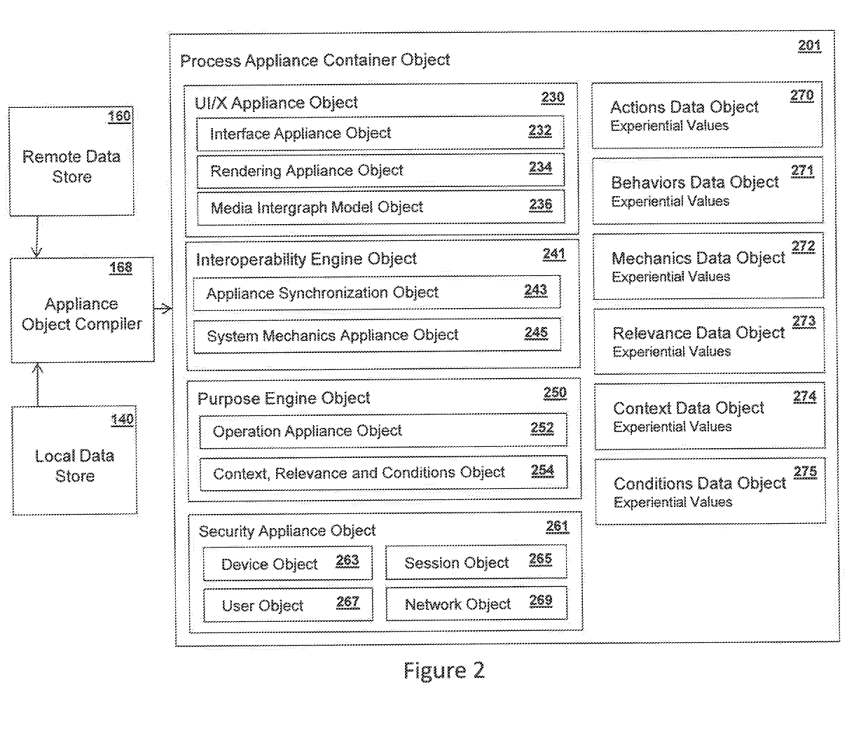

FIG. 2 illustrates a process appliance container (PAQ) or a PAQ object, in accordance with an embodiment of the present disclosure. In certain embodiments, a process appliance may include computer codes/instructions (e.g., core logic or executable appliance objects) and computer data/functional parameters (e.g., functional elements or non-executable data objects) designed for a particular purpose, so as to instruct a computer hardware to perform certain functions. In one embodiment, the computer codes/instructions may be written in a scripting language (e.g., JavaScript and the like) that is executable on a computer hardware through a web browser program.

As shown in FIG. 1, computer system 100 includes a terminal device 160, a local data storage device 140, and a remote data storage device 110. Terminal device 160 may be a digital hardware (e.g., a desktop computer, a laptop computer, a tablet computer, a smart phone, a game device, and the like) including a microprocessor and a display screen, and configured with networking technology, such as a web browser program and a rendering engine. Although physical hardware is always required as the underlying infrastructure for terminal device 160, it is appreciated that, in certain embodiments, some or all components of terminal device 160 may be virtualized as software emulated hardware devices (e.g., a virtual machine). Accordingly, in one embodiment, PAQs may consider both physical and emulated computer hardware components of terminal device 160 as “devices.”

In one implementation, local data storage device 140 may be accessed by terminal device 160 through a device net (DN) 109. In one embodiment, the PAQ containers can create an operational super-local network within the confines of terminal device 160, acting as a separate operating system (a.k.a., ZuOS™) that runs through the web browser technology. DN 109 establishes an environment by which diverse software and program standards can interoperate and exchange data.

In one embodiment, local data storage device 140 includes one or more device drives 145, which may be a hard drive or a solid-state flash memory device, to receive and store local data as directed by PAQs. Local data may include persistent data, databases, and data objects that exist exclusively inside the confines of terminal device 160 and are accessed, manipulated and compiled through PAQs. Such persistent data is available for use directly from terminal device 160 without the need for updating from the network, such as Internet 103.

In one embodiment, local storage device 140 includes one or more device caches 143 configured in device drives 145. Browser enabled devices generally include web caching systems and storage mechanisms to enable caching in firmware or hard drives. PAQs can store persistent data into device caches 143 to maximize data flow efficiency and minimize network interaction. In contrast to persistent data stored in device drives 145, it is appreciated that outdated persistent data stored in device caches 143 may be overwritten by other data after being stored in device caches 143 for a predetermined period of time.

In one embodiment, previously compiled and utilized PAQ objects are stored in device caches 143 and/or device drives 145 as local appliance objects 147, and are ready for use in terminal device 160 with minimal or no network interaction.

In one embodiment, local storage device 140 includes an asset processor 149 to receive requests from DN 109. In response, asset processor 149 retrieves and compiles the necessary digital assets (e.g., data stored in device drives 145 or device caches 143) for the PAQ in accordance with the request. Asset processor 149 considers the purpose, type, definition and parameters of the request and delivers such assets to operational layers 162-178 of terminal device 160.

In one implementation, remote data storage device 110 may be accessed by terminal device 160 through Internet 103. In one embodiment, process appliances are directed by PAQ functions through network mechanism 107 resident on terminal device 160 and into Internet 103. PAQs may dynamically configure network mechanism 107 resident on terminal device 160 in accordance with the operating system and/or platform, hardware version and configuration, and firmware configurations related to network interaction. It is appreciated that process appliances directed through network mechanism 107 may also be directed through a network other than Internet 103, such as a wide-area network (WAN), a local area network (LAN), or micro area network (MAN), generally referred to as configured networks 105. In such cases, the PAQ is dynamically configured according to the specific network configuration.

In one embodiment, remote data storage device 110 includes one or more remote drives 114, such as an array of disk drives. PAQs may access remote drives 114 to retrieve remote data and pass the retrieved data to operational layers 162-178 of terminal device 160. Remote data includes persistent data, databases, and data objects that exist outside the confines of terminal device 160 and are accessed, manipulated, and compiled through PAQs.

In one embodiment, remote data are hosted by one or more remote database servers 112 (e.g., MySQL, DB2, and the like) executed on remote data storage device 110. PAQs can access remote servers 112 to retrieve remote data and pass the accessed remote data to operational layers 162-178 of terminal device 160.

In one embodiment, remote data storage device 110 further includes one or more cold storage drives 116 to store latent data. PAQs can access remote cold storage drives 116 to retrieve the latent data, configure the latent data for operations, and pass the latent data to operational layers 162-178 of terminal device 160. In one embodiment, latent data may be those data that are not accessed for a predetermined time period (e.g., one week, one month, and the like).

In one embodiment, remote data storage device 110 includes remote appliance objects 118. Remote appliance objects 118 may be those objects and functions compiled into usable appliances and stored in remote data storage device 110. Remote data storage device 110 can be retrieved, configured or reconfigured, and then passed along to operational layers 162-178 of terminal device 160 via PAQs.

In one embodiment, remote data storage device 110 includes an asset processor 120. As requests are received by remote data storage device 110, asset processor 120 can retrieve and compile the necessary digital assets (including, for example, remote appliance objects 118, the latent data stored in cold storage drives 116, and the remote data stored in remote drives 112) for the PAQ to respond to the request. Asset processor 120 considers the purpose, type, definition and parameters of the request and delivers such assets to operational layers 162-178 of terminal device 160.

In one embodiment, remote data storage device 110 includes a core logic library (CLL) 122. Asset processor 120 may first consider CLL 122 when digital assets are retrieved in response to a request. CLL 120 is a library of pre-configured functions and process logic initially stored only in remote data storage device 110 and accessible through remote servers 112. Such core logic, when gathered and contained within a PAQ is then stored within that PAQ wherever that PAQ is deployed, which can include other remote servers, remote drives, in remote appliance objects; and in resident device caches and resident device drives.

In one implementation, upon signing into a web portal of the disclosed computer system using a web browser program, terminal device 160 may load a seed PAQ into its memory and execute the seed PAQ through the web browser program to render contents. The seed PAQ, when executed on terminal device 160, constitutes one or more of operational layers 162-178, including a consumption interface 162, a user interface and use experience (UI/X) rendering mechanism 164, an appliance object compiler 168, an interoperability engine 170, a purpose engine 172, an abstraction layer 174, a request/response compiler 176, and a security layer 178. It is appreciated that, depending on design choices or the web browser technology, at least some of layers 162-178 may be built into a web browser software program as one or more of its default modules. In one embodiment, the seed PAQ can be used to retrieve and compile additional PAQs, and concatenate such additional PAQs with the seed PAQ, thereby rendering contents to be consumed by the web browser program (or “bootstrapping” the ZuOS™).

In one embodiment, terminal device 160 includes consumption interface 162 executed thereon as instructed by the PAQ. Consumption interface 162 may be a graphic user interface shown on a display screen of terminal device 160. Consumption interface 162 allows a user to input information into terminal device 160 through finger touches or cursor movements. Consumption interface 162 may receive information from rendering mechanism 164 for display and interaction. PAQs direct protocols and specifications through consumption interface 162 and rendering mechanism 164 in response to user requests.

In one embodiment, terminal device 160 includes user interface and use experience (UI/X) rendering mechanism 164 executed thereon as instructed by the PAQ. UI/X rendering mechanism 164 receives compiled, operational appliances from appliance object compiler 168 of the PAQ that directs the rendering apparatus (such as, a graphics card, browser rendering engine, and a display screen) of terminal device 160.

In one embodiment, appliance objects are configured into consumable (usable) appliances through the PAQ's appliance object compiler (AOC) 168 that is executed on terminal device 160 and operates as a device operational layer. In alternative embodiments, AOC 168 can be either stored in a persistent storage of terminal device 160, or transient, via temporary, operational storage in one of the caches of terminal device 160. AOC 168 can receive information from the PAQ's interoperability engine 170 and purpose engine 172, and receive compiled request/response information from request/response compiler 176 that is curated through abstraction layer 174 of terminal device 160.

In one embodiment, terminal device 160 includes interoperability engine 170 executed thereon as instructed by the PAQ. Interoperability engine 170 includes functions and appliances to enable interoperability between other digital systems 180 upon user request. Such functions may be retrieved via the operations of remote and local asset processor 120 and 149.

In one embodiment, terminal device 160 includes purpose engine 172 executed thereon as instructed by the PAQ. The PAQ may compile functions and appliances according to the general and specific purposes of the contained process appliance. Purposes are generated by user request and compiled in configurations that answer the request.

In one embodiment, terminal device 160 includes an abstraction layer 174 executed thereon as instructed by the PAQ. Various PAQs may be configured to operate with abstraction layer parameters of the hosting device, considering hardware, operating system, firmware and network configuration. In one embodiment, abstraction layer 174 can be a standalone PAQ or a PAQ concatenated with one or more other PAQs.

In one embodiment, terminal device 160 includes request/response compiler 176 executed thereon as instructed by the PAQ. Individual and compound requests are compiled from user and system interaction and relayed to the remote and local asset processors 120 and 149 for asset retrieval.

In one embodiment, terminal device 160 includes a security layer 178 executed thereon as instructed by the PAQ. The PAQ may be configured to operate in conjunction with the security operations of terminal device 160 through security layer 178. Security layer 178 may be configured to specific platforms and systems. PAQ configuration of security layer 178 occurs as a result of interaction between terminal device 160 and request/response compiler 176.

FIG. 2 illustrates a process appliance container (PAQ) object 201, in accordance with an embodiment of the present disclosure. PAQ object 201 may be a dynamically assembled container comprising a plurality of programmed objects capable of delivering a process appliance or appliances to the user interface of a terminal device through the computer system 100 for creation, deployment, consumption and management of a process appliance container (PAQ) as shown in FIG. 1.

As shown in FIG. 2, in one embodiment, PAQ object 201 may be compiled using appliance object compiler 168 to gather (executable and non-executable) functions and objects from remote data storage device 110 and local data storage device 140. In one embodiment, appliance object compiler 168 itself may be a standalone PAQ or concatenated with another PAQ, and delivered to and executed on terminal device 160, thereby compiling PAQ object 201. PAQ object 201 may be compiled into useful process appliances in accordance with system requests and information (such as, actions data object 270, behaviors data object 271, mechanics data object 272, relevance data object 273, context data object 274, and conditions data object 275) pulled from remote data storage device 160 and local data storage device 140. Such useful process appliances can then be delivered to a user of terminal device 160 through a compiled PAQ object 201. APPENDIX A below shows an exemplary implementation of appliance object compiler 168 in pseudo code.

In one embodiment, PAQ object 201 includes a UI/X appliance object 230. When executed, UI/X appliance object 230 directs and instructs device rendering mechanism 164 and consumption interface 162 to act according to parameters of the deployed PAQ object 201.

UI/X appliance object 230 may include an interface appliance object 232, which includes interface functions that direct and instruct consumption interface 162, typically a browser program, to perform directed operations in response to system requests.

UI/X appliance object 230 may further include a rendering appliance object 234, which includes display rendering functions that direct and instruct rendering mechanism 164, typically a graphics co-processor and display engine, to perform directed operations in response to system requests.

UI/X appliance object 230 may further include a media intergraph model (MIM) object 236. Layout, style, and appliance position can be mapped out according to media intergraph model standards that operate as compiled function objects directing consumption interface 162, rendering mechanism 164, interoperability engine 170, purpose engine 172 and device abstraction layer 174 on how to organize and display UI/X and rendering objects.

In one embodiment, PAQ object 201 includes an interoperability engine object 241. When executed, interoperability engine object 241 directs the function of interoperability between disparate digital computer systems 180. Interoperability engine object 241 may include an appliance synchronization object 243 and a system mechanics appliance object 245.

Mechanical attributes of computer system 100 (including, for example, hardware, software, firmware, and network) may be encapsulated in system mechanics appliance object 245, which serves to turn on or turn off mechanical properties within computer system 100 that enables performance of response to system requests.

Appliance synchronization object 243 may receive directions from system mechanics appliance object 245, and direct synchronization operations between Application Programming Interfaces (API). In alternative embodiments, appliance synchronization object 243 may receive instructions from system mechanics appliance object 245 and compiled instructions derived from the API itself.

In one embodiment, PAQ object 201 includes a purpose engine object 250 including an operation appliance object 252 and a context, relevance, and conditions object 254. The purpose of an appliance is derived from operation appliance object 252 and context, relevance and conditions object 254, and then compiled into purpose engine object 250 that provides directives to interoperability engine object 241 to enable process appliance operations.

Functions are gathered and compiled into operation appliance object 252 through appliance object compiler 168, providing the operational characteristics of an appliance to the purpose engine object 250. Part of the purpose of an appliance is derived from experiential data gathered from relevance data object 273, context data object 274, and conditions data object 275 for use in purpose engine object 250.

In one embodiment, PAQ object 201 includes a security appliance object 261 to govern the access to devices and data. Security appliance object 261 may include a device security object 263, a session ID object 265, a user data object 267, and a network security protocol object 269.

Device security object 263 (or, simply, device object 263) may store device identification data, user/device security data (such as, keychain data), and device security protocol data for utilization by security appliance object 261.

Session ID object 265 (or, simply, session object 265) may store session data, update data, and mobility change-state data for utilization by security appliance object 261.

User data object 267 (or, simply, user object 267) may store user security data and encrypted user password data for utilization by security appliance object 261.

Network object 269 may store network connection and security protocols for utilization by security appliance object 261.

In one embodiment, experiential data and/or existent relevance data derived from the usage of computer system 100 can be stored in remote data storage device 160 and local data storage device 140 and compiled into actions data object 270, behaviors data object 271, mechanics data object 272, relevance data object 273, context data object 274, and/or conditions data object 275.

Actions data object 270 includes experiential data derived from user and system actions, compiled toward specific uses by appliance object compiler 168 and deployed within operation appliance object 252 of purpose engine object 250.

Behavior Data Object 271 includes experiential data derived from user and system behaviors, compiled toward specific uses by appliance object compiler 168 and deployed within operation appliance object 252 of purpose engine object 250.

Mechanics data object 272 includes experiential data derived from system configurations and functions, compiled toward specific uses by appliance object compiler 168 and deployed within operation appliance object 252 of purpose engine object 250.

Relevance data object 273 includes experiential and existent relevance data derived from user/system requests and historical operations, and operator/application requests and historical operations, compiled toward specific uses by appliance object compiler 168 and deployed within context, relevance, and conditions object 254 of purpose engine object 250.

Context data object 274 includes experiential and existent context data derived from user/system requests and historical operations, and operator/application requests and historical operations, compiled toward specific uses by appliance object compiler 168 and deployed within the context, relevance, and conditions object 254 of purpose engine object 250.

Conditions data object 275 includes experiential and existent conditions data derived from user/system requests and historical operations, and operator/application requests and historical operations, compiled toward specific uses by appliance object compiler 168 and deployed within context, relevance, and conditions object 254 of purpose engine object 250.

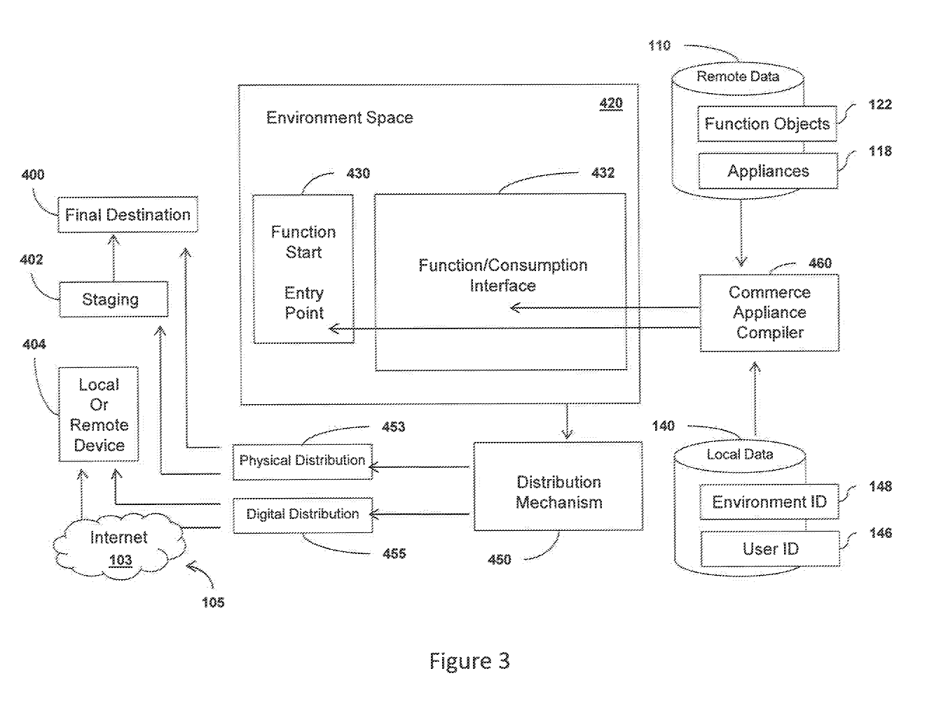

FIG. 3 illustrates a computer system architecture for creation, deployment, and consumption of commerce process appliances, in accordance with an embodiment of the present disclosure. Commerce process appliances may include modules of an electronic storefront for trading products and/or services via computer networks.

In one embodiment, the commerce process appliances are directed by PAQ functions through configured networks 105, including network mechanism 107 resident on terminal device 160 and into Internet 103. The PAQ can configure dynamically for network mechanism 107. In alternative embodiments, process appliances directed through network mechanism 107 may be directed through a network other than Internet 103, such as a wide-area network (WAN), a local area network (LAN), or a micro area network (MN), and a metro area network (MAN). In such cases, the PAQ may be dynamically configured according to the specific network configuration. APPENDIX B below shows an exemplary implementation of network mechanism 107 in pseudo code.

In one embodiment, an environment space 420 can be a graphical user interface rendered by, for example, a web browser program to display and consume (e.g., use or execute) process appliances. Environment space 420 can display a commerce appliance function start and entry point 430 and an appliance function/consumption interface 432.

In one embodiment, informed by data from environment space 420, a commerce appliance compiler 460 can access remote data storage device 110 to compile distribution functions from function objects 122 and appliance objects 118, and access local data storage device 140 to compile user ID data 146 and user environment ID data 148, thereby dynamically generating commerce appliance objects. In one embodiment, commerce appliance compiler 460 can be executed on terminal device 160 using a web browser program. The commerce appliance objects, when executed by terminal device 160, result in integrated function start/entry point 430, function/consumption interface 432, and a distribution mechanism 450. Distribution mechanism 450 may be an object appliance that culls information from environment space 420, remote data storage device 110, and local data storage device 141 to create specifically configured distribution appliances in order to direct physical and/or digital goods (or services) through physical distribution 453 or digital distribution 455. APPENDIX C below shows an exemplary implementation of commerce appliance compiler 460 in pseudo code.

In one embodiment, function start/entry point 430 is the entry point, an appliance information updater and function start, and an access point for commerce appliances. Function/consumption interface 432 attached to function start/entry point 430 may be hidden until activated by a user's interaction with function start/entry point 430 through click or drag functions. Function start/entry point 430 may be displayed in environment space 420 as directed by commerce appliance compiler 460 after function objects are gathered from local data storage device 140 and remote data storage device 110.

In one embodiment, commerce appliances are displayed in and consumed from within function/consumption interface 432. Function start/entry point 430 can activate and display function/consumption interface 432 through click or drag functions. Function/consumption interface 432 can be displayed into environment space 420 as directed by commerce appliance compiler 460 after function objects are gathered from local data storage device 140 and remote data storage device 110.

In one embodiment, the commerce process appliances facilitate trading physical and/or digital goods. Delivery of the physical and/or digital goods can be directed by distribution mechanism 450 through physical distribution 453 or digital distribution 455.

Physical distribution 453 is a suite of objects assembled into a physical distribution appliance, directing the distribution points of physical goods to a staging 402 area or a final destination 400. Final destination 400 represents the final delivery destination for physical goods as directed by distribution mechanism 450 and passed through a physical distribution appliance 453, directly landing at final destination 400 or a distribution staging area 402. Staging area 402 represents an intermediate delivery destination for physical goods as directed by distribution mechanism 450 and passed through a physical distribution appliance 453, and on its way to the goods' final destination 400.

Digital distribution 455 is a suite of objects assembled into a digital distribution appliance, directing the distribution points of digital goods or services to a local or remote device 404 through a digital distribution channel (i.e., Internet 103 or configured network 105). Commerce goods or services delivered by digital means are delivered to an appropriate local or remote device 404 as directed by distribution mechanism 450 and passing through digital distribution 455 appliance, then either landing at the local device or a remote device 404 after passing through the digital distribution channel.

Process Appliance Container (PAQ) Operation

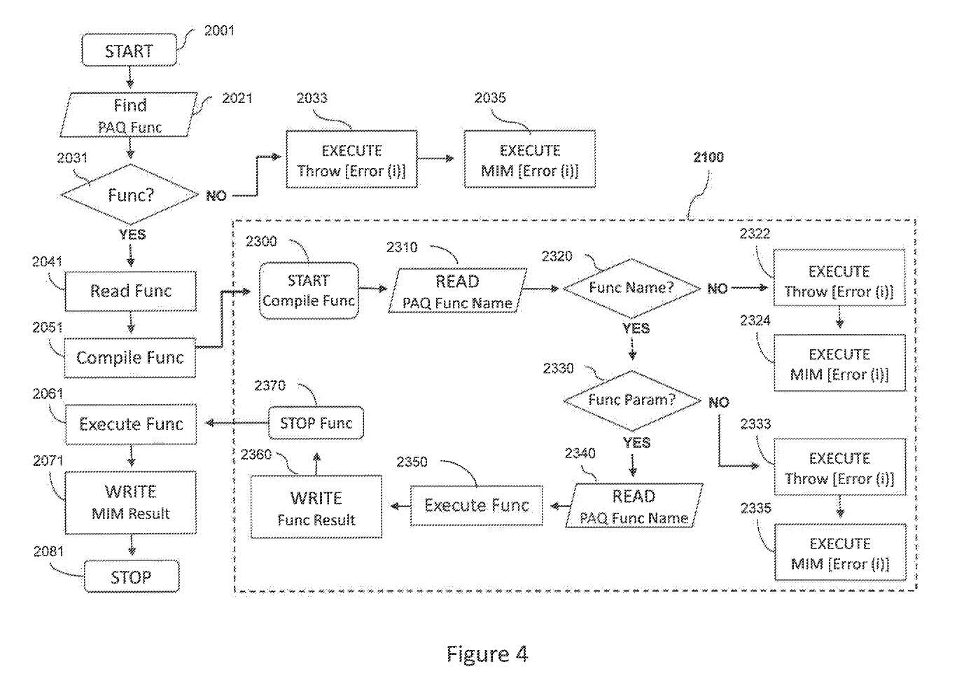

FIG. 4 illustrates a flowchart for a PAQ and PAQ code compiler operation, in accordance with an embodiment of the present disclosure. In one embodiment, the PAQ code compiler operation can be coded in a suitable scripting language (e.g., JavaScript and the like) and performed by a processor of terminal device 160 through a web browser program. As shown in FIG. 4, in Step 2001, the Process Appliance Container (PAQ) operation begins with an event call (or a triggering event) to request a desired operation function/purpose. Such event calls can emanate from the Media Intergraph Model (MIM) user interface, a server call event, or a device generated call event. In Step 2021, the call event in Step 2001 directs a search for the appropriate PAQ function.

In Step 2031, the PAQ operation determines whether an appropriate PAQ function exists. If an appropriate function exists, the answer is “yes” and the process moves to Step 2041 to read the function parameters and values. If an appropriate function for the event call does not exist or is corrupted, the process proceeds to Step 2033. In Step 2033, a Throw Error function (a sub-routine function name) is initiated to provide an error result and proceeds to Step 2035. In Step 2035, the error result is received by an Execute MIM Error function (a sub-routine function name), which displays an error message in accordance with the error result through the MIM. The error message may be displayed through the user interface and generates a method to create a new event call.

In Step 2041, when an appropriate function is located, the process reads the function parameters and values and then moves on to Step 2051 to execute a Compile Function, which is the gateway into the PAQ Compiler Mechanism. In Step 2051, the Compile Function sends an “event call” into PAQ Compiler Mechanism loop 2100 to begin code compilation that enables the functions to be read by a browser through the MIM.

Once the code of a PAQ is compiled in the PAQ Compiler Mechanism loop 2100, the PAQ becomes available for use and is sent to Step 2061. In Step 2061, the PAQ is executed through an Execute Function and then sent to a Write Function in Step 2071 for display through the MIM. The compiled PAQ Operation can be “written” for display in the browser's rendering engine through the MIM and then ceases operation in Step 2081. The compilation process is no longer necessary after the realization of the operation and ceases code compilation until another event call is placed.

Hereafter, PAQ Compiler Mechanism loop 2100 is described in further detail. In one embodiment, when PAQ Compiler Mechanism loop 2100 can be implemented to include a plurality of sub-routines. In Step 2300, PAQ Function parameters and values are received from the Compile Function in Step 2051 to begin the process of compiling code for browser reading and rendering. In Step 2310, the sub-routine begins with a Read Function of the PAQ Function Name. The Compiler function process in Step 2051 first seeks an appropriate PAQ Function name and then sends the search information to Step 2320 to decide whether an appropriate function name exists. If an appropriate function name exists the answer is “yes” and the process moves to Step 2330 to decide and ascertain whether the function parameters and values are intact and appropriate.

If an appropriate function name does not exist or is corrupted, the process proceeds to Step 2322. In Step 2322, a Throw Error function (a sub-routine function name) is initiated and executed to provide an error result and proceeds to Step 2324. In Step 2324, the error result is received by an Execute MIM Error function (a sub-routine function name), which displays an error message in accordance with the error result through the MIM. The error message may be displayed through the user interface and generates a method to create a new event call.

In Step 2330, PAQ Compiler Mechanism loop 2100 determines whether the function parameters and values are intact and appropriate. If appropriate and intact function parameters and values exist, then the answer is “yes” and the process moves to the Read PAQ function in Step 2340, where the function parameters and values are read and then sent to an Execute function in Step 2350. If an appropriate parameters or values does not exist or is corrupted, the process proceeds to Step 2333. In Step 2033, a Throw Error function (a sub-routine function name) is initiated to provide an error result and proceeds to Step 2335. In Step 2035, the error result is received by an Execute MIM Error function (a sub-routine function name), which displays an error message in accordance with the error result through the MIM. The error message may be displayed through the user interface and generates a method to create a new event call.

In Step 2340, the Read PAQ Function receives the “go” message (or the “yes” answer) from the function parameters decision in Step 2330 and proceeds to read the parameters and values of the function. Once read, the information is sent to an Execute Function in Step 2350 to run the routine. In Step 2350, once the parameters and values of the function are read, an Execute Function is performed and sent to a Write Result function in Step 2360. Upon execution, in Step 2360, the results of the sub-routine operation are written to the main operation Execute Function in Step 2061 for execution and writing to the Write MIM Result function in Step 2071 for display in the browser's rendering engine, and the PAQ operation process stops in Step 2081.

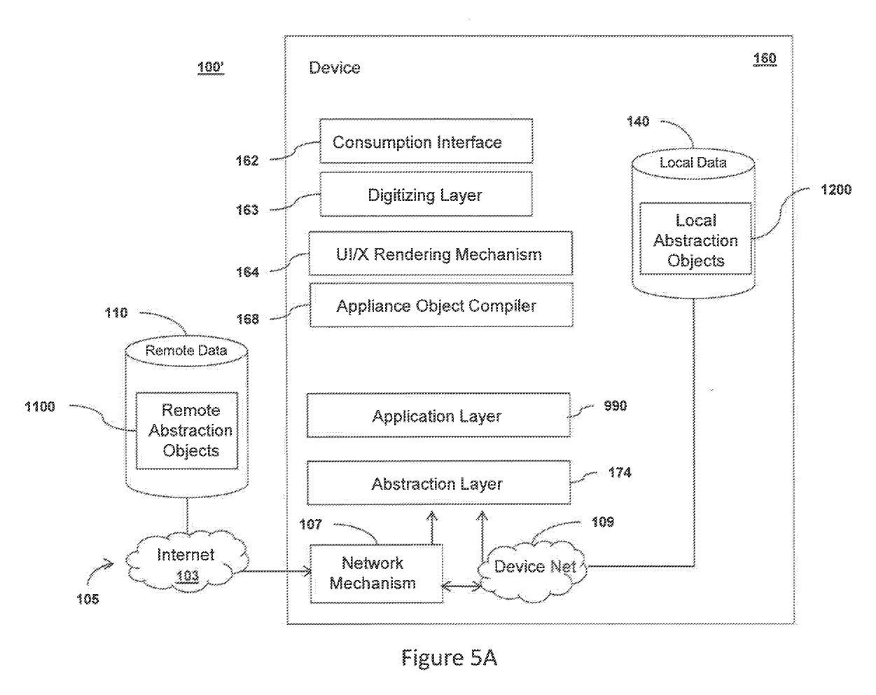

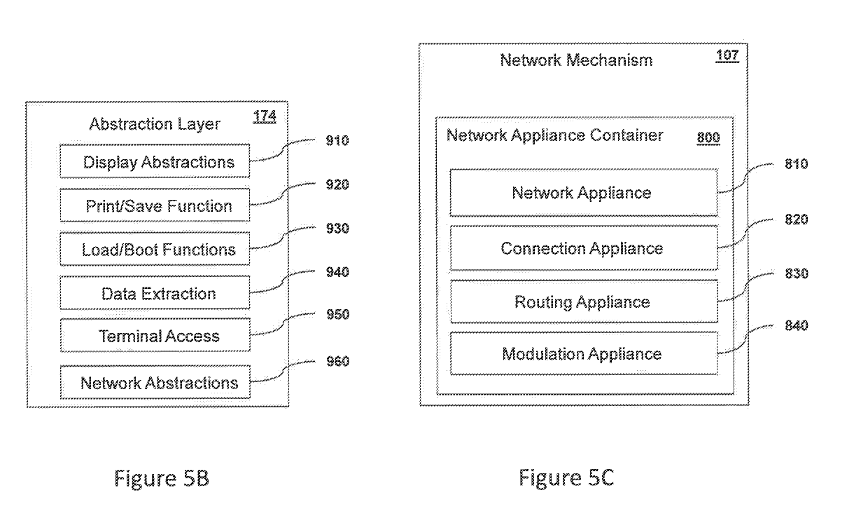

FIG. 5A illustrates a computer system 100′ for creation, deployment, consumption and management of a process appliance container (PAQ), in accordance with another embodiment of the present disclosure. The computer system 100′ shown in FIG. 5 is similar to the computer system 100 shown in FIG. 1, and same or similar components in computer systems 100 and 100′ are labeled by same or similar reference numerals.

Referring to FIG. 5A, computer system 100′ comprises a terminal device 160, a local data storage device 140 in terminal device 160, and a remote data storage device 110. Terminal device 160 may be a digital computer hardware (e.g., a desktop computer, a laptop computer, a tablet computer, a smart phone, a game device, and the like) including a microprocessor and a display screen, and configured with networking technology, such as a web browser program and a rendering engine. Although physical computer hardware is always required as the underlying infrastructure for terminal device 160, it is appreciated that, in certain embodiments, some or all components of terminal device 160 may be virtualized as software emulated hardware devices (e.g., a virtual machine). Accordingly, in one embodiment, PAQs may consider both physical or emulated hardware components of terminal device 160 as “devices.”

Terminal device 160 can access remote data storage device 110 through Internet 103 using a network mechanism 107 of terminal device 160. It is appreciated that every device and operating system that can connect to a computer network includes a connection mechanism (such as network mechanism 107). PAQs may be configured to such mechanisms, accounting for the operating system and/or platform, the hardware version and configuration, and/or the firmware configurations related to network interaction.

In one embodiment, process appliances can be directed by PAQ functions through network mechanism 107 resident on terminal device 160 and into Internet 103. The PAQ configures dynamically for the particular network mechanism 107 resident on terminal device 160. In an alternative embodiment, process appliances directed through network mechanism 107 may also be directed through a network other than Internet 103, such as a wide-area network (WAN), a local area network (LAN), or micro area network (MAN). In such cases, the PAQ is dynamically configured according to a network configuration (or configured networks 105).

In one embodiment, PAQ containers can create an operational super-local network (e.g., device net (DN) 109) within the confines of terminal device 160, acting as a separate operating system that runs through browser technology. DN 109 can establish an environment by which diverse software and program standards can interoperate and exchange data.

In one embodiment, remote data storage device 110 includes data, databases, and/or data objects that exist outside the confines of terminal device 160, and may be accessed, manipulated and compiled through, for example, configured networks 105 using PAQs. In one embodiment, remote data storage device 110 comprises remote abstraction objects 1100. Remote abstraction objects 1100 may be assembled into PAQs and ready for being transported to terminal device 160 when called from abstraction layer 174. Assets of remote abstraction objects 1100 are gathered and compiled from remote appliance objects 118 stored in remote data drive 114 (shown in FIG. 1). Once transported to terminal device 160, remote abstraction objects 1100 are stored in data storage device 140 (or device caches 143 and device drives 145 as shown in FIG. 1) as local abstraction objects 1200.

In one embodiment, local data storage device 140 includes data, databases, and/or data objects that exist exclusively inside the confines of terminal device 160 and may be accessed, manipulated, and compiled through PAQs. Local abstraction objects 1200 may be stored in local data storage device 140 and assembled into PAQs ready for use when called from abstraction layer 174. Assets are gathered and compiled from local appliance objects 147 stored in local device drives 145 and local device caches 143 (shown FIG. 1). When abstractions are first-use by terminal device 160 or updated to terminal device 160, new or updated assets are gathered and compiled from remote appliance objects 118 stored in remote data drives 114 (shown in FIG. 1).

In one embodiment, terminal device 160 includes a consumption interface 162, which can be a touch sensitive screen that receive input from, for example, finger touches or cursor movements. Consumption interface 162 receives information from rendering layer/mechanism 164 for display purposes, and digitizing layer/mechanism 163 for user interaction. PAQs direct protocols and specifications through both layers 164 and 163 in response to user requests.

In one embodiment, User Interface and Use Experience (UI/X) rendering layer 164 receives compiled, operational appliances from the PAQ's appliance object compiler 168 that directs the rendering apparatus of terminal device 160, such as, graphics card, browser rendering engine, and display screen.

In one embodiment, terminal device 160 includes an application layer 990, including application software drivers and objects. Application layer 990 may be called by a PAQ compiled by appliance object compiler 168 and executed by a web browser program. Application layer 990 may send a request to abstraction layer 174 for function needs of the application software drivers and objects residing in application layer 990. Abstraction layer 174 in turn may then call/retrieve abstraction objects 1100 and/or 1200 from remote data storage device 110 and/or local data storage device 140 to fulfill the function needs.

Hereafter, abstraction layer 174 is described in further detail with reference to FIG. 5B. In one embodiment, PAQs are configured to operate with abstraction layer 174, which interfaces software appliances (e.g., PAQs) with the device hardware, in some sense similar to the device drivers included in conventional operating systems. Abstraction layer 174 may include parameters of the device host, considering hardware, operating system, firmware, and network configurations.

In one embodiment, abstraction layer 174 includes display abstractions 910, which may include compiled and stored abstractions in the form of a PAQ, which is configured to access and utilize UI/X rendering mechanism 164 and consumption interface 162 for purposes of data display and manipulation. In certain embodiments, display abstractions 910 may be a standalone PAQ, acting as a device driver, or concatenated with other PAQs.

In one embodiment, abstraction layer 174 includes print/save function abstractions 920, which may include stored abstractions in the form of a PAQ, used to access print/save function device drivers stored locally in and/or remotely from terminal device 160. Print/save function abstractions 920 may act as a device driver to encapsulate data changes ported through software in application layer 990 of terminal device 160. In certain embodiments, print/save function abstractions 920 may be a standalone PAQ, acting as a device driver, or concatenated with other PAQs.

In one embodiment, abstraction layer 174 includes load/boot functions abstractions 930, which may include stored abstractions in the form of a PAQ, used to access and utilize software and hardware load and/or boot functions. Load/boot function abstractions 930 may act as device drivers to load software or boot hardware elements to display through UI/X rendering mechanism 164 of terminal device 160 for manipulation and use through consumption interface 162. In certain embodiments, load/boot functions abstractions 930 may be a standalone PAQ, acting as a device driver, or concatenated with other PAQs.

In one embodiment, abstraction layer 174 includes data extraction abstractions 940, which may include stored abstractions in the form of a PAQ, used to extract data from software and firmware resident on terminal device 160 and display such data in conjunction with other local data and remote data. Conjoined data displayed and manipulated through consumption interface 162 and encapsulated by print/save function abstractions 920 generate a new, interoperable data set for storage locally and/or remotely. In certain embodiments, data extraction abstractions 940 may be a standalone PAQ, acting as a device driver, or concatenated with other PAQs.

In one embodiment, abstraction layer 174 includes terminal access abstractions 950, which may include stored abstractions in the form of a PAQ, used to access device terminal console(s). Terminal access abstractions 950 may act in concert with device security layer 178 (shown in FIG. 1) for account and hardware verification to open local gateways to data extraction abstractions 940. Such abstractions, whether stored locally or remotely operate only in security layer 174, rendering mechanism 164, and consumption layer 162 of terminal device 160. In certain embodiments, terminal access abstractions 950 may be a standalone PAQ, acting as a device driver, or concatenated with other PAQs.

In one embodiment, abstraction layer 174 includes network abstractions 960 to interact with network mechanism 107 or device net 109.

FIG. 5C illustrates details of network mechanism 107 shown in FIG. 5A. Referring to FIG. 5C, in one embodiment, network mechanism 107 comprises a network appliance container 800 including a network appliance 810, a connection appliance 820, a routing appliance 830, and a modulation appliance 840.

Exemplary Implementations

The disclosed system offers a core suite or basic package that enables organizations and users to establish an initial presence, branded as their business or person, and build a base of associates. In various embodiments of the present disclosure, a systems of the present disclosure can be implemented to provide the following:
Enterprise Platform—Intranet Management; Extranet Management; Exonet Management.
Development Framework—Enterprise Account Implementation; Application Development; Process Space Development.
Integrated Networks—Impact Commerce Engine (Marketing and Sales Distribution and Transaction Console); ProConnX Professional Network (Profiles and Communities); SoapBox Media Distribution and Management; Venturist Collaboration and Project Management; SQAN Data Distribution Management.
Integrated Task Applications—Application (APPs) Management; Bulletin Board and Memo Distribution; Message Center; Calendar, Address Book; File Management and Storage; Organization Development and Management; Community Integration and Management; Peer-to-Peer Communications (Video Chat; Text Chat; and Instant Messaging); Workspace Distribution and Management.
Integrated Process Spaces—Account Curation and Summary Space; Process Organization and Function Space; Space Management and Administration.

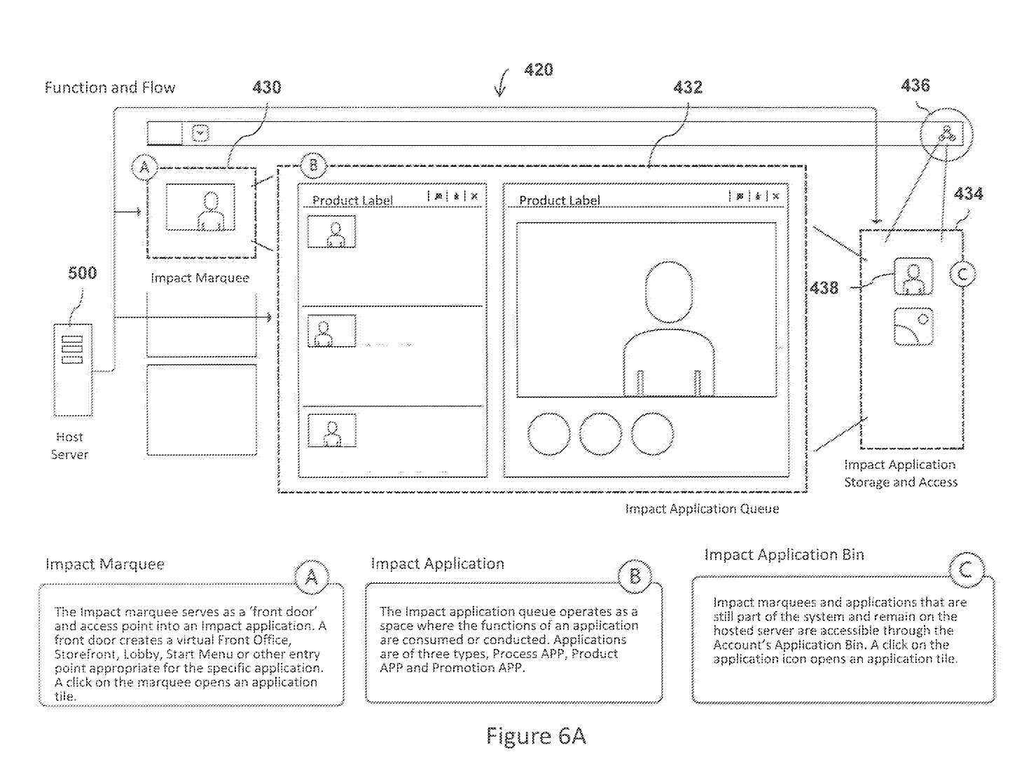

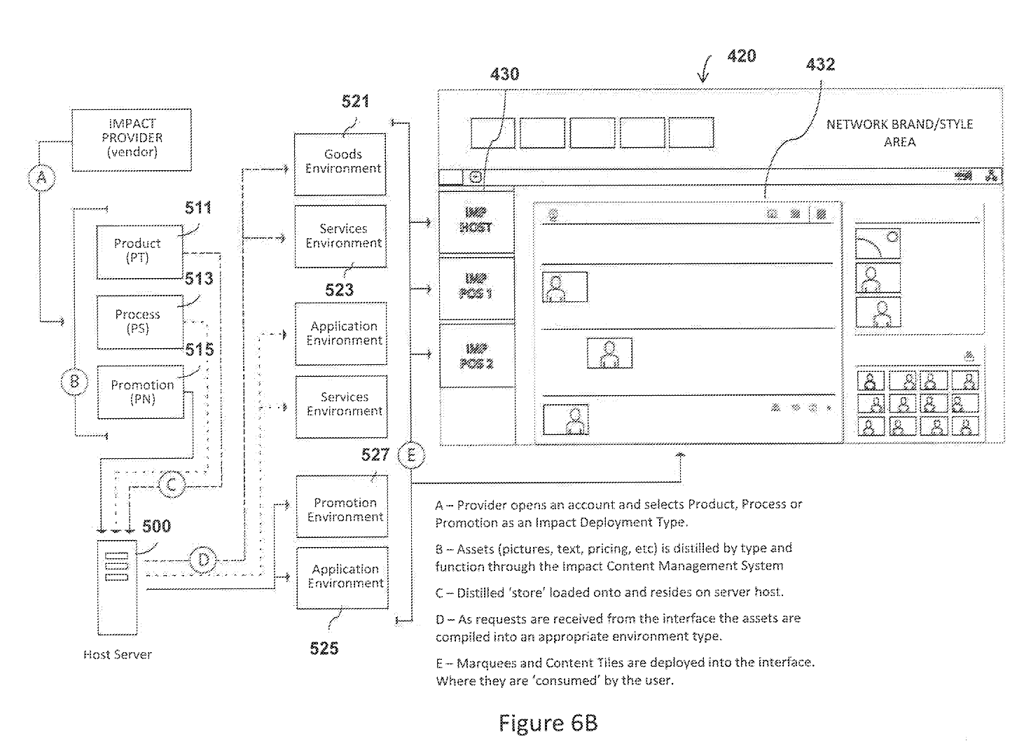

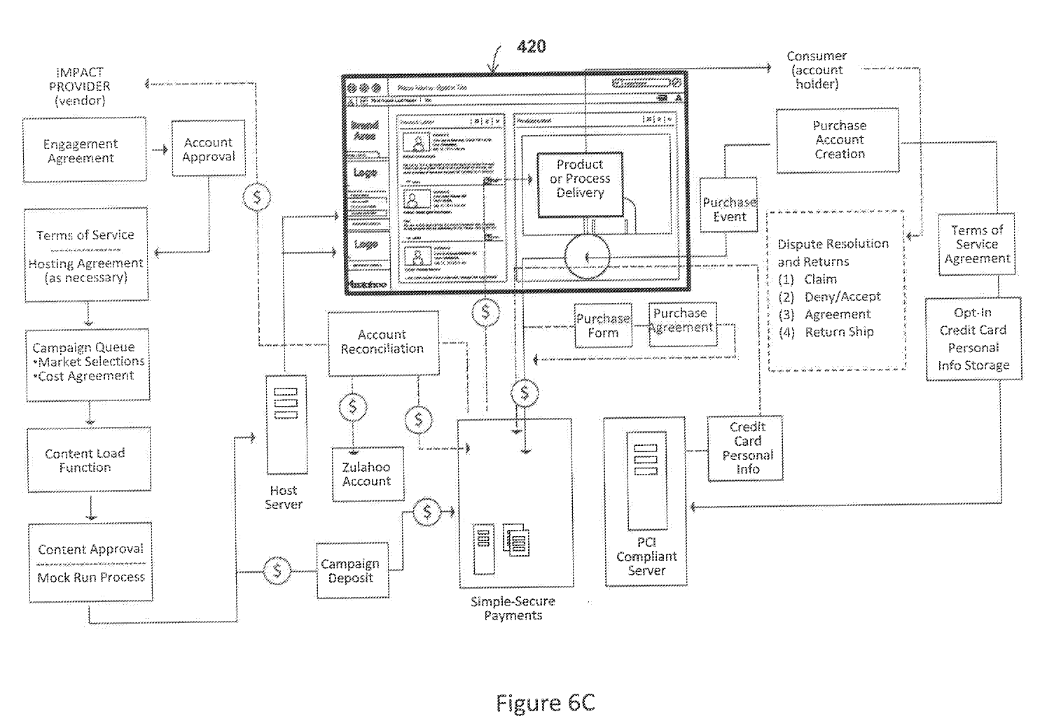

FIGS. 6A-6C schematically illustrate the basic operation, provider function, and provider/user flow of a commerce network system, in accordance with an embodiment of the present disclosure.

Referring to FIG. 6A, where the basic operation of the commerce network system is shown, the commerce network system of the present disclosure includes an environmental space 420 displayed on a computer screen of terminal device 160. In one embodiment, environmental space 420 may be a graphical user interface rendered by a web browser program, upon a user logging into the system. As shown in FIG. 6A, environmental space 420 includes a function start/entry point 430 (a.k.a., Impact marquee), a function consumption interface 432 (a.k.a., Impact application), and an application bin 434. In one embodiment, environmental space 420 can be rendered by commerce appliance compiler 460 executed on terminal device 160 based on data retrieved from a hosted server 500.

In one embodiment, a user is required to sign up for the commerce network system prior to logging into the system. During the sign up process, for example, various contextual and relevant data may be gathered and generated. Accordingly, prior to the user login, the system already knows certain information about the user, such as the type and purpose of the user's community, age and gender of the user, time of day of the user logins, number of communities that the user participates, etc.

In one embodiment, every operation of the commerce network system is executed through a PAQ. As such, even the initial processes (e.g., login) of the commerce network system are executed through, for example, a Core PAQ. In certain embodiments, the Core PAQ includes a Login PAQ that executes the login protocols and then renders an appropriate graphical user interface for environment space 420. The Login Core PAQ is accessed by the user's activity on sign-up, and then modified for that particular user by additional user activity (such as, answering security questions or selecting color schemes). Once created, the specifically modified Login Core PAQ is re-accessed every time the user accesses the login process. Once the basic system is accessed (made up of several Core PAQs), the user's activity continues to modify those PAQs associated with the user.

Upon user login, the system simply returns a result (e.g., an initial PAQ) based on the user data/information associated with the user that is already stored in the system, and/or the provider data/information associated with the user. The initial PAQ is then used to render a graphical user interface for environmental space 420 upon the user's login to include, for example, three Impact marquees 430, as shown in FIG. 6B.

In one embodiment, Impact marquee 430 serves as a “front door” and an access point into an Impact application 432. For example, Impact marquee 430 can create a virtual Front Office, a Store Front, a Lobby, a Start Menu, or other entry point appropriate for specific applications. In one embodiment, a click (using either a pointer device or a finger) on the Impact marquee 430 executes a first PAQ associated with the clicked Impact marquee 430 to compile a second PAQ in accordance with the present disclosure. The second PAQ is then loaded and executed by the web browser program to render and open an Impact application queue/tile 432 in environmental space 420.

In one embodiment, Impact application queue/tile 432 can operate as a space, where the functions of an application are consumed or conducted. Applications can be one of three types, Process APP, Product APP, and Promotion APP.

In one embodiment, environmental space 420 can display application bin 434 upon clicking on a start button 436. Application bin 434 collects Impact applications 432 that are currently active (i.e., still a part of the system) and remain on hosted server 160. A user can easily access a desired Impact application 432 by clicking on an icon 438 in application bin 434 that represents the desired Impact application 432, so as to open an application tile for the desired Impact application 432.

Referring to FIG. 6B, where the provider function of the commerce network system is shown, the commerce network system of the present disclosure allows a provider/vendor to open an account. The provider then selects Product 511, Process 513, or Promotion 515 as an Impact Deployment Type. Assets (e.g., pictures, text, pricing, etc.) may be distilled by type and function through the Impact Content Management System. The distilled assets (or “store”) may then be loaded onto and resides on server host 500. As requests are received from the user interface environment 420, the assets are compiled into an appropriate environment type (e.g., goods environment 521, services environment 523, application environment 525, and promotion environment 527). Marquee 430 and Content Tiles 432 can then be deployed into the user interface environment 420, where these assets are “consumed” by the user.

Referring to FIG. 6C, where the provider/user flow of a commerce network system is shown, an Impact provider may open a vendor account and a consumer can open a user account.

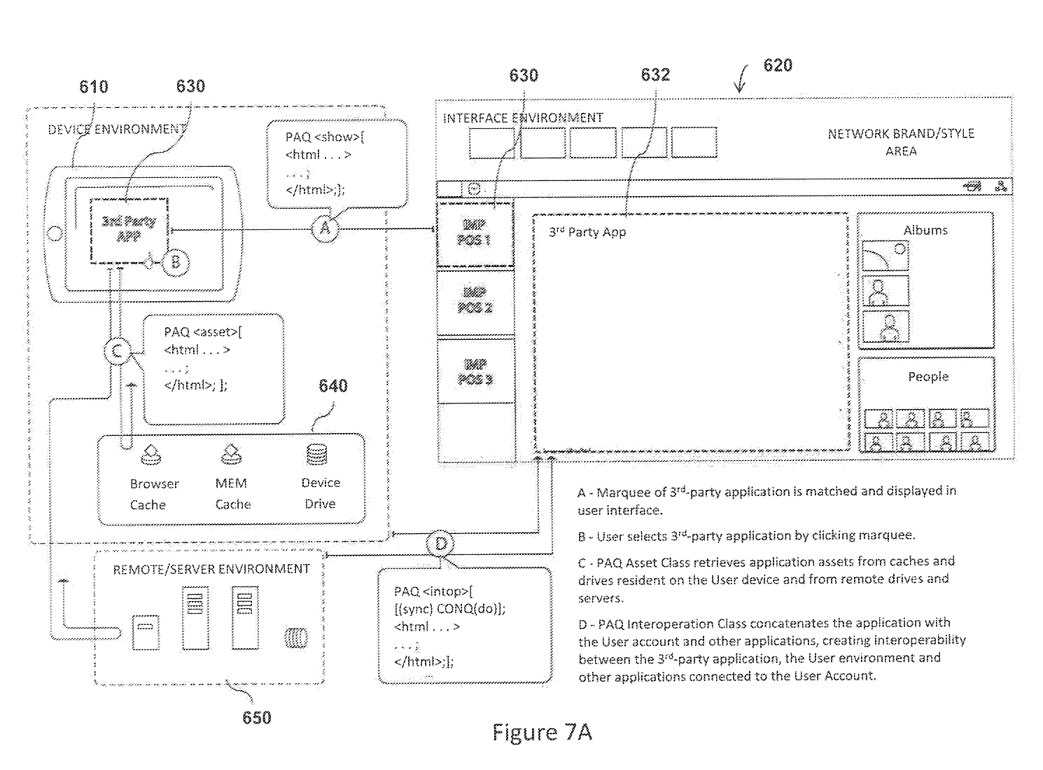

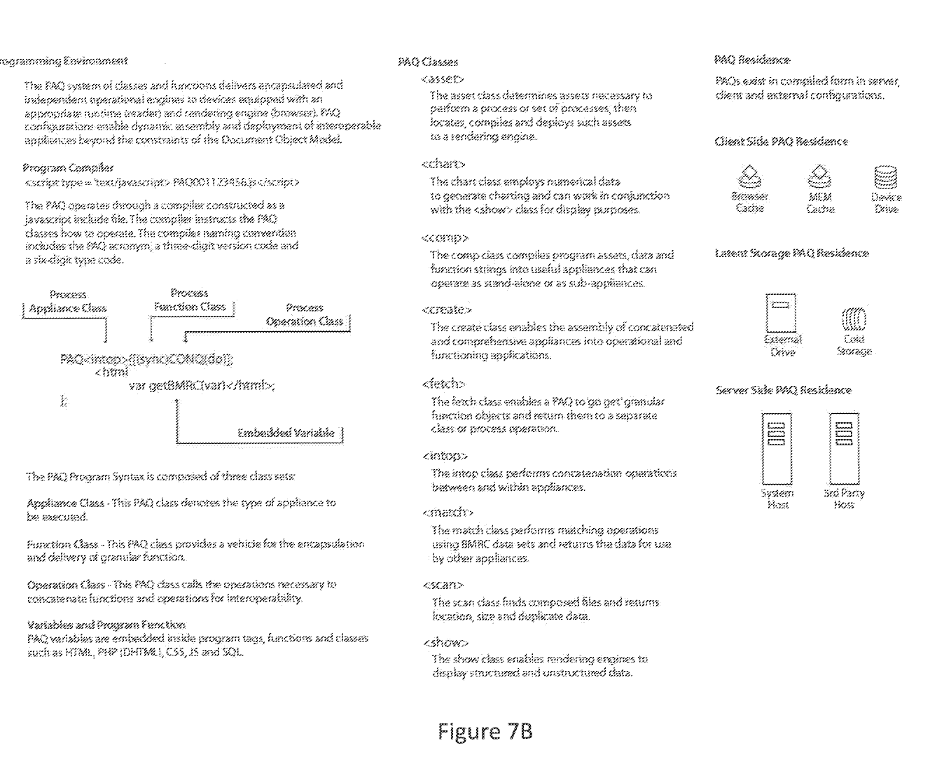

FIGS. 7A and 7B schematically illustrate the access, interoperability, and program properties of a process appliance container (PAQ), in accordance with an embodiment of the present disclosure. In various embodiments, PAQs can exist in compiled form in server, client, and external configurations.

Referring to FIG. 7A, a user interface environment 620 is shown when a user logs into the user account. In one embodiment, a marquee 630 of a third party application is matched with the user account in accordance with, for example, actions and conditions of the user, and displayed in user interface environment 620. For example, if the user is a certified public accountant (CPA), the third party application may be an accounting software, such as QuickBooks. The user can then select the third party application by clicking on marquee 630.

Upon selection of the third party application, a PAQ Asset Class retrieves application assets from caches and drives 640 resident on user device 610 and/or from remote drives and servers 650. The PAQ Interoperation Class then concatenates the application with the user account as well as other applications, thereby creating interoperability between the third party application, the user interface environment 620, and other applications connected to the user account.

In one embodiment, the PAQ system of classes and functions delivers encapsulated and independent operational engines to devices equipped with an appropriate runtime (reader) and rendering engine, such as a web browser program. PAQ configurations may enable dynamic assembly and deployment of interoperable appliances beyond the constraints of the Document Object Model (DOM).

In one embodiment, the PAQ can operate through a compiler constructed as a JavaScript INCLUDE file. The compiler instructs the PAQ classes how to operate. The compiler naming convention includes the PAQ acronym, a three-digit version code and a six-digit type code, as shown in FIG. 7B. The PAQ Program Syntax is composed of three class sets: (1) Appliance Class-this PAQ class denotes the type of appliance to be executed; (2) Function Class—this PAQ class provides a vehicle for the encapsulation and delivery of granular function; and (3) Operation Class—this PAQ class calls the operations necessary to concatenate functions and operations for interoperability. PAQ variables may be embedded inside program tags, functions and classes, such as HTML, PHP (DHTML), CSS, JS and SQL.

In one embodiment, PAQ classes may include a <asset> class, a <chart> class, a <comp> class, a <create> class, a <fetch> class, a <intop> class, a <match> class, a <scan> class, and a <show> class. The <asset> class determines assets necessary to perform a process or set of processes, then locates, compiles and deploys such assets to a rendering engine. The <chart> class employs numerical data to generate charting and can work in conjunction with the <show> class for display purposes. The <comp> class compiles program assets, data and function strings into useful appliances that can operate as stand-alone or as sub-appliances. The <create> class enables the assembly of concatenated and comprehensive appliances into operational and functioning applications. The <fetch> class enables a PAQ to “go get” granular function objects and return them to a separate class or process operation. The <intop> class performs concatenation operations between and within appliances. The <match> class performs matching operations using BMRC data sets and returns the data for use by other appliances. The <scan> class finds composed files and returns location, size and duplicate data. The <show> class enables rendering engines to display structured and unstructured data.

For the purposes of describing and defining the present disclosure, it is noted that the term “substantially” may be utilized herein to represent the inherent degree of uncertainty that may be attributed to any quantitative comparison, value, measurement, or other representation. The term “substantially” may also be utilized herein to represent the degree by which a quantitative representation may vary from a stated reference without resulting in a change in the basic function of the subject matter at issue.

Further, for the purposes of describing and defining the present disclosure, it is noted that the term “configured to” may be utilized herein to represent a computer usable media having computer readable code embodied therein, the computer readable code being executed in a processor to perform certain method steps.

Although embodiments of the present disclosure have been described in detail, it is to be understood that these embodiments are provided for exemplary and illustrative purposes only. Various modifications and changes may be made by persons skilled in the art without departing from the spirit and scope of the present disclosure.

APPENDIX A
Exemplary pseudo code for appliance object compiler 168.

// Compiler Name: PAQ[type][version]
adobj - Action Data Object
bdobj - Behavior Data Object
mdobj - Mechanism Data Object
rdobj - Relevance Data Object
cdobj - Context Data Object
cndobj - Condition Data Object
PAQ(aoc){

| | |
|---|---|
| getadobj(var); | // Get Action Data Object |
| getbdobj(var); | // Get Action Data Object |
| getmdobj(var); | // Get Action Data Object |
| getrdobj(var); | // Get Action Data Object |
| getcdobj(var); | // Get Action Data Object |
| getcndobj(var); | // Get Action Data Object |

| | |
|---|---|
| fnremotedatastore( ); | //Remote Data Store Function |
| fndevicedatastore( ); | //Local/Device Data Store Function |
| fnaoc( ); | |

}
// PAQ Functions:
PAQ getadobj(var -> remote or local){
Check var -> remote or local;

| | |
|---|---|
| If remote then | //get remote value |

Check adobj;
If exists then

Read adobj;

Else

Create adobj:

Execute Func;
Write adobj;

| | |
|---|---|
| Else if local then | //get local value |

Check adobj;
If exists then

Read adobj;

Else

Create adobj;

Execute Func;
Write adobj;

}
PAQ fnremotedatastore(obj) {

| | |
|---|---|
| Read obj; | // obj -> {adobj, bdobj, mdobj, rdobj, cdobj, |
| | cndobj} - remote |

Execute func(obj);
Compute Result;
Write Result;

}
PAQ fnremotedatastore( ) {

Var robj;
robj{

adobj <- getadobj(‘remote’);
bdobj <- getbdobj(‘remote’);
mdobj <- getmdobj(‘remote’);
rdobj <- getrdobj(‘remote’);
cdobj <- getcdobj(‘remote’);
cndobj <- getcndobj(‘remote’);

}
Execute func(robj);
Compute Result;
Write Result;

}
PAQ fndevicedatastore (obj) {

| | |
|---|---|
| Read obj; | // obj -> {adobj, bdobj, mdobj, rdobj, cdobj, |
| | cndobj} - local |

Execute func(obj);
Compute Result;
Write Result;

}
PAQ fndevicedatastore( ) {

Var dobj;
dobj{

adobj <- getadobj(‘local’);
bdobj <- getbdobj(‘local’);
mdobj <- getmdobj(‘local’);
rdobj <- getrdobj(‘local’);
cdobj <- getcdobj(‘local’);
cndobj <- getcndobj(‘local’);

}
Execute func(dobj);
Compute Result;
Write Result;

}
PAQ fnaoc( ){

Execute fnremotedatastore( );
Execute fndevicedatastore( );
Compute [remoteobject, localobject];
Execute Func[remoteobject, localobject];
Write Result;

}

APPENDIX B
Exemplary pseudo code for network mechanism 107.

```
// Compiler Name: PAQ[type][version]
PAQ(nw){
  getdevice( );
  getos( );
  getbrowser( );
  getcomputername( );
  getnw( );
  getip( );
  gethardwareid( );
}
// PAQ functions:
PAQ getdevice( ){
  Read device; //execute code
  Write device;
}
PAQ getos( ){
  Read os;
  Write os;
}
PAQ getbrowser( ){
  Read browser;
  Read browserversion;
  Write browser~browserversion;
}
PAQ getcomputername( ){
  Read computername;
  Write computername;
}
PAQ getip ( ){
  Read ip;
  Write ip;
}
PAQ gethardwareid ( ){
  Read hardwareid;
  Write hardwareid;
}
PAQ getnw( ){
  Read device;
  Read os;
  Read browser;
  Read browserversion;
  Read computername;
  Read ip;
  Read hardwareid;
  Write device~ os~ browser~browserversion~
  computername~ip~hardwareid;
}
```

```
APPENDIX C
Exemplary pseudo code for commerce appliance compiler 460.
// Compiler Name; PAQ[type][version]
PAQ(cac){
  getremotedata( ); //Get Remote Data [functionobject~appliances]
  getlocaldata( ); //Get Local Data [userid~environmentid]
  fncac( ); //Commerce Appliance Compiler Function
}
// PAQ Functions:
PAQ getremotedata( ){
  Read functionobjects;
  Read appliances;
  Compute functionobjects~appliances;
  Write functionobjects~appliances;
}
PAQ getlocaldata( ){
  Read userid;
  Read environmentid;
  Write userid~environmentid;
}
PAQ fncac( ) {
  Execute getlocaldata( );
  Execute getremotedata(userid);
  Compute func[localdata, remotedata];
  Execute func;
  Write Result[marquee~data~distributionmechanism(physical or digital)]
}
```

1. A computer system, comprising:
a network-enabled terminal device including at least a processor, a memory, and a display device;
a web browser program stored in the memory and executable by the processor to provide visual output to the display device;
a process appliance compiler stored in the memory and executable by the processor through the web browser program, the process appliance compiler being configured to retrieve appliance objects and data objects from one or more sources;
a process appliance container (PAQ) object dynamically generated by the process appliance compiler, the process appliance container object being stored in the memory and executable by the processor through the web browser program, the process appliance container object comprising one or more of the appliance objects and one or more of the data objects; and
a rendering engine distinct from that of the web browser program configured to render any visual output from the process appliance container object.

2. The computer system of claim 1, wherein the appliance objects are executable through the web browser program and the data objects are non-executable.

3. The computer system of claim 2, wherein said one or more appliance objects comprise codes of a scripting language.

4. The computer system of claim 1, wherein the appliance objects comprise one or more of user interface/user experience (UI/X) appliance object, an interoperability engine object, a purpose engine object, and a security appliance object.

5. The computer system of claim 4, wherein the UI/X appliance object comprises one or more of an interface appliance object, a rendering appliance object, and a media intergraph model object.

6. The computer system of claim 4, wherein the interoperability engine object comprises one or more of an appliance synchronization object and a system mechanics appliance object.

7. The computer system of claim 4, wherein the purpose engine object comprises one or more of an operation appliance object, and a context, relevance and conditions object.

8. The computer system of claim 4, wherein the security appliance object comprises one or more of a device object, a session object, a user object, and a network object.

9. The computer system of claim 1, wherein the data objects comprise one or more of an actions data object, a behaviors data object, a mechanics data object, a relevance data object, a context data object, and a conditions data object.

10. The computer system of claim 1, wherein the network-enabled terminal device further includes a persistent local data storage device configured to store local process appliance container objects.

11. The computer system of claim 10, wherein the persistent local data storage device comprises a local asset processor configured to retrieve and compile digital assets into one or more of the local process appliance container objects in accordance with a request received through interaction with the visual output.

12. The computer system of claim 1, further comprising a persistent remote data storage device accessible by the network-enabled terminal device through a computer network, the persistent remote data storage device being configured to store remote process appliance container objects and a core logic library.

13. The computer system of claim 12, wherein the persistent remote data storage device comprises a remote asset processor configured to retrieve and compile digital assets from the core logic library into one or more of the remote process appliance container objects in accordance with a request received through interaction with the visual output.

14. The computer system of claim 13, wherein the remote process appliance container objects are hosted by a database server.

15. A network-enabled computer apparatus, comprising:
computer hardware including a processor, an input device, and an output device;
a web browser program executed by the processor to receive user input from the input device and provide visual output to the output device;
a seed process appliance retrieved from a server device remote from the computer hardware and executed through an application;
a plurality of process appliances generated by the seed process appliance and executed by the processor through an application, the process appliances including one or more appliance objects and one or more data objects retrieved from one or more sources and concatenated by the seed process appliance;
wherein said plurality of process appliances comprises:
an abstraction layer configured to provide an interface between the computer hardware and one or more of the executed process appliances;
an appliance object compiler configured to generate a process appliance container object based on digital assets retrieved from one or more sources;
an application layer configured to execute the process appliance container object through the web browser program;
a rendering mechanism configured to render content of the visual output in accordance with the executed process appliance container object;
a consumption interface configured to output the rendered content to the output device; and
a digitizing layer configured to process user interaction from the input device.

16. The apparatus of claim 15, wherein the abstraction layer comprises one or more of display abstractions, print/save abstractions, load/boot abstractions, data extraction abstractions, and terminal access abstractions.

17. The apparatus of claim 15, wherein the application layer comprises application software drivers and objects.

18. The apparatus of claim 15, wherein the abstraction layer comprises a first process appliance container object generated by the appliance object compiler.

19. The apparatus of claim 18, wherein said plurality of process appliances further comprises a software-defined data exchange network within the confines of the apparatus acting as a separate operating system that runs through the web browser program.

20. The apparatus of claim 19, wherein the first process appliance container object comprises local abstraction objects retrieved from a local data storage device through the software-defined data exchange network.

21. The apparatus of claim 18, wherein said plurality of process appliances further comprises a network mechanism.

22. The apparatus of claim 21, wherein the first process appliance container object comprises remote abstraction objects retrieved from a remote data storage device through the network mechanism.

23. The apparatus of claim 18, wherein the first process appliance container object comprises local abstraction objects retrieved from a local data storage device and remote abstraction objects retrieved from a remote data storage device.

24. A method for enabling interoperability between digital systems, comprising:
retrieving a seed process appliance from a remote server device through a computer network;
generating a process appliance container by executing the seed process appliance to retrieve two or more process appliances from one or more sources and concatenating said two or more process appliances, the process appliance container comprising core logic and functional elements associated with the core logic;
transmitting the process appliance container to a process interpolation terminal; and
rendering an output on the process interpolation terminal in accordance with the core logic and the functional elements of the process appliance container.

25. The method of claim 24, wherein each of the process appliances comprises a modeling expression associated therewith.

26. The method of claim 24, wherein the modeling expression comprises behavior expression, context expression, mechanics expression, and relevance expression.

27. The method of claim 24, wherein generating the process appliance container comprises
reading a persistent expression from a data store, the persistent expression being associated with a standard process appliance;
receiving a convection expression from an operator through the process interpolation terminal;
receiving a boost expression from a creator through the data store; comparing the convection expression and the boost expression;
concatenating the convection expression and the boost expression to obtain a matching expressing; and
generating the process appliance container in accordance with the matching expressing.

28. A system for enabling interoperability between digital systems, comprising:
a process appliance concatenation apparatus (PACA) configured to generate a process appliance container including one or more process appliances;
an interoperable managed process appliance concatenation terminal (IMPACT) configured to store and distribute the process appliances; and
a processes interpolation/interchange platform (PIP) configured to consume the process appliances through a user interface and user experience platform of the PIP;
wherein the PACA is configured to dynamically generate the process appliance container by retrieving some of the process appliances stored in the IMPACT; and
wherein the process appliances comprise data objects including experiential data derived from user and system behaviors.

29. The system of claim 28, wherein the user interface and user experience platform comprises a web browser.

30. The system of claim 28, further comprising a data store configured to store the process appliance container.
